(19) United States
(12) Patent Application Publication
(10) Pub. No.: US 2009/0214309 A1
(43) Pub. Date: Aug. 27, 2009

(54) High performance cutting tools

(76) Inventors: John X. Rees, Lindsey, CA (US); Edward M. Sybesma, Porterville, CA (US)

Correspondence Address: DENNIS B. HAASE, P.O. BOX 6206, HOT SPRINGS, AR, 71902-6206, US

(21) Appl. No.: 12/072,060

(22) Filed: Feb. 25, 2008

(51) Int. Cl. B23B 27/14; B23B 51/02; B23B 51/00

(52) U.S. Cl. 408/144; 408/227; 408/229

(57) ABSTRACT

An improved cutting tool for drilling complex holes in a workpiece such as an automotive aluminum wheel, in which the tool has a shank and an integrally formed support section. A cutter insert secured in the support section. The cutter insert is formed with opposed flutes along the longitudinal axis of the tool. The tool is improved by reducing cutting forces and optimizing chip disposal, thereby cutting costs by reducing the load requirements for drilling holes, and this is accomplished by creating a positive rake angle at the flutes.

The present invention relates to cutting tools for the cutting of complex holes and, more particularly, to such cutting tools which offer an improved efficiency in the process of cutting such holes in automotive aluminum wheels by lowering power requirements for operating the tool.

### BACKGROUND OF THE INVENTION

1. Field of the Invention

The cutting tool of the present invention is more commonly referred to as a combination form or step drill. Not any drill, however. It serves a particular, high tech, purpose in that it is intended to form the lug nut holes in aluminum wheels, such as those intended for use on automobiles. These holes are not run of the mill. Rather, they are difficult and somewhat complex to cut efficiently, and the material exacerbates the difficulty.

It is inherent in such tools that the amount of energy needed to drive the tool is not insignificant. In the mid 90's, energy concerns were less of a concern than is the case today. As a consequence, efforts are ongoing to find ways to conserve energy, and it is to this facet of the art that the present invention has particular utility. Additionally, the industry is constantly seeking improvements which would permit greater drilling speeds with less deflection and all around greater efficiency.

2. Overview of the Prior Art

The inventors of the present improvement are recognized as the inventors or another patent of great significance in this specialized field, namely U.S. Pat. No. 5,570,978. That patent was directed to a cutting tool having a pair of straight sided flutes which are slotted to receive a carbide tip. The tool itself is structured to efficiently cut a complex hole. An improved design has increased the efficiency of the tool in use by reducing the amount of power required to drill a given hole.

A search revealed little, if any, relevant prior art, although Sekigushi et al., U.S. Pat. No. 6,315,504; Anjanappa et al., U.S. Pat. No. 6,345,940; Plummer U.S. Pat. No. 6,283,682 and Mast et al., U.S. Pat. No. 6,676,342, were reviewed as being of general interest.

### SUMMARY OF THE INVENTION

At a time when energy concerns dominate world markets, it is an overriding objective of the present invention to provide a cutting tool which succeeds in providing the user with a significant reduction in cutting forces in use, cycle time and optimum chip evacuation over comparable tools, including that of the inventors' previous patented tool, all of which is reflected in increased efficiency.

It is another objective, related to the foregoing, to provide the energy savings attributable to the present invention in a high performance drill especially suitable for cutting complex holes in materials such as aluminum.

It is a further objective to provide such a tool in which side forces are reduced and deflection of the tool is minimized, thereby reducing lateral deflection of the tool, with a commensurate increase in the accuracy of the hole drilled. All of the foregoing results in a decrease in the overall wear and tear on the machine with a coincident decrease in maintenance costs. And finally, it is an objective to facilitate is chip removal as the drill advances through the workpiece.

The foregoing, as well as other objects and advantages, will become apparent to those skilled in the art from a reading of the following Detailed Description of a Preferred Embodiment, when read in conjunction with the drawings, wherein:

### BRIEF DESCRIPTION OF THE DRAWINGS

FIG. 1 is side elevation of the high performance cutting tool of the present invention with its longitudinal axis in a vertical attitude;

FIG. 2 is view of the tool of FIG. 1 with the tool broken away to emphasize the flute section and rotated approximately 45 degrees about its longitudinal axis and with the shank broken way to emphasize the rake;

FIG. 3 is a top plan view of the cutting tool of FIG. 1 in which a linear grind has resulted in an angled flute in accordance with the present invention;

FIG. 4 is a top plan view of the cutting tool as it would appear if subjected to a helical, rather than a linear, grind;

FIG. 5 is a side elevation of the carbide insert set in the tool;

FIG. 6 is an exploded view of the tool of FIG. 1, illustrating the inter relationship of the carbide tip and the body of the tool;

FIG. 7 is a side elevation of the carbide tip shown in considerable FIG. 5; and,

FIG. 8 is a partial section view of a typical wheel in which a lug hole, e.g., an automotive aluminum wheel, in which a counter bore is formed by the tool of the present invention.

### DETAILED DESCRIPTION OF A PREFERRED EMBODIMENT

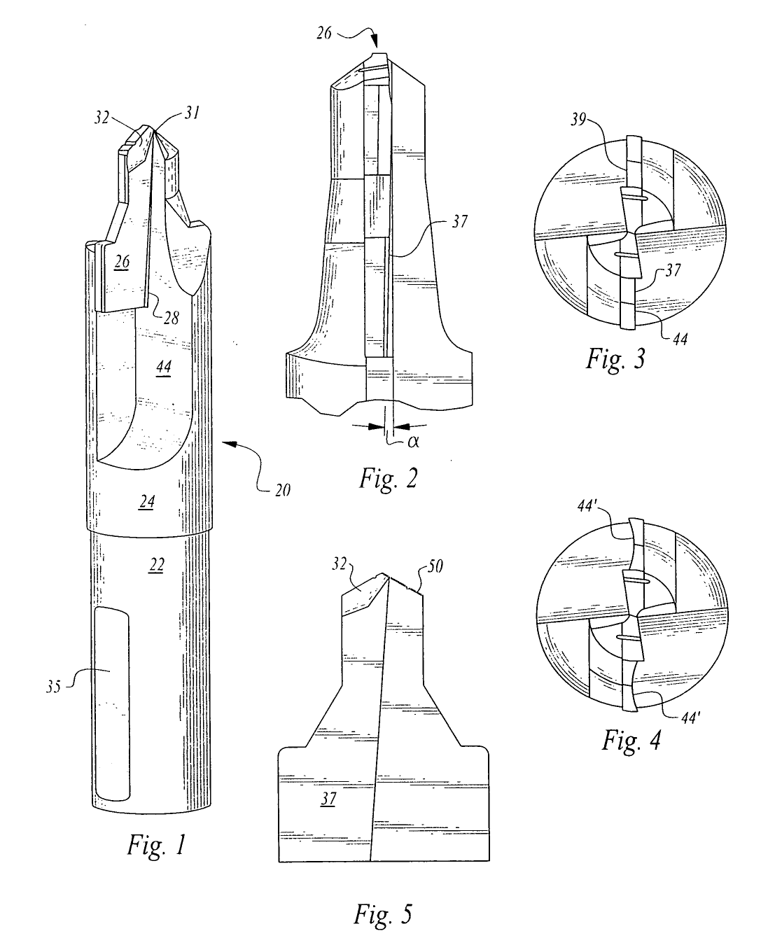

With reference now to the drawings, and initially to FIG. 1, a cutting tool 20, embodying the improvements of the present invention is there shown.

The cutting tool 20 is in the nature of a drill and is especially adapted for use in cutting complex lug holes in a workpiece W, such as aluminum wheels, intended for use on a variety of vehicles.

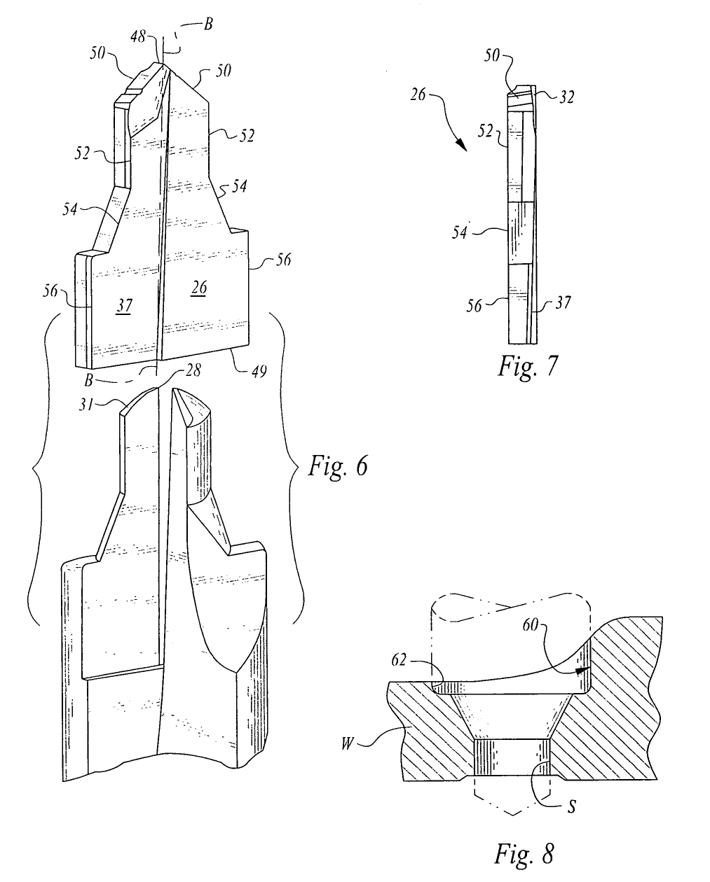

Structurally, the cutting tool 20 resembles, in some respects, that of our cutting tool, as taught in our earlier U.S. Pat. No. 5,570,978, in that it comprises an elongate cylindrical body formed with a shank 22 and an integrally formed support section 24, which receives and holds, in supporting relation, a cutting element of a hardened material, in this instance a carbide insert element 26. In operation, however, it provides performance improvements which may not be immediately visually apparent. The support section is formed with a slot 28 [FIG. 6] beginning at its apex, or drill point, 31 and extending inwardly along the longitudinal axis of the tool. The slot receives and rigidly supports the carbide insert 26. The carbide insert is brazed into the slot, preferably with tri-ply solder where it is supported to minimize deflection as it functions to cut the lug hole S, depicted in FIG. 8, as the cutting tool 20 is rotated.

Structurally, the carbide insert is similar in appearance to that taught in the above referenced '978 patent, but with significant structural differences, as will be explained in considerable detail hereinafter.

The carbide insert 26, as best shown in FIG. 6, is essentially symmetric in profile about a central longitudinal axis B-B, and includes a tip section terminating in an axially disposed drill tip 48, from which stepped chisels, or cutting edges, 50, extend outwardly and rearwardly, as seen in FIG. 6, at an acute angle from the central terminus, or tip, 48, which, as previously discussed, is disposed at the forward most point, defining the drill point of the tool on the longitudinal axis B-B of the insert 26.

Depending from the surfaces 50, again as seen in FIG. 6, there are parallel cutting edges 52, themselves coplaner with the longitudinal axis B-B of the insert 26. The cutting edges 52 cut, dress and hone the lug hole [denominated generally as “S” in the workpiece “W” and detailed at FIG. 8] so as to receive a nut to be secured on a wheel stud in a well known manner [neither of which are shown].

There is further provided, opposed, flared cutting edges 54, which extend outwardly from the center of the insert 26 as they are stepped downwardly, as depicted in FIG. 6. The edges 54 are sharpened and serve to cut away material to form a counterbore in the lug hole as the drill is advanced into the work piece, to provide a frusto-conical shaped area above that portion of the hole that represents the hole for receipt of a stud, which extends outwardly from the hub assembly of a typical automobile. The counterbore is dimensioned to receive and seat the lug nut which is threaded on to the stud to hold the wheel in place.

stepping down from the end of the flared surfaces 54, there are radially, outwardly extending transverse cutting edges 56. The edges 56 serve to counterbore the stud hole 60 [FIG. 8] above the frusto-conical section. This counterbore 62 serves to receive the lug nut with sufficient clearance to permit the use of a lug wrench to torque down, and/or remove the lug nut.

The insert 26 terminates in a base 56 where it rests at the base of the slot. The base of the insert 56 serves as reaction members against which rotary forces generated on the drill are transmitted to the insert. Additionally, the edges of the base 56 are sharpened, and when the tool is rotated, establish the diameter of the counterbore.

The shank 22 is formed with a flat 35, and the shank is received in the end mill holder of a machine, in a well known manner, used to rotate the tool, e.g. a drilling machine [not shown]. In the instance shown, the tool rotates in a clockwise direction.

With reference once again to the insert 26 of the present invention, and to FIGS. 1, 2 and 6 in particular, the insert 26 is defined by opposed side walls in the nature of flutes 37, 39. It is the perimeter surfaces of the side walls which form the sharpened edges 50, 52, 54, 56.

In keeping with the objectives of the invention, each of the flutes, beginning at the tip 48 of the insert, disposed at the longitudinal axis of the tool, and extending to the base 49 thereof, define an arcuate path leading to the establishment of a positive rake angle shown as an angle a, best seen in FIG. 2. In so doing, the tool experiences performance which accomplishes the objectives of the invention, including, inter alia, markedly more efficient chip disposal. The angle a will vary with several parameters, e.g., variously by the diameter of the cutting tool, its length, and its overall configuration, and, for a typical such tool, it will range, e.g., between ¼ and 5 degrees.

In keeping with the objectives of the invention as articulated above, and in contradistinction to other such drills, including that taught in the previously discussed '978 patent, interior walls 44 define a cavity, or recess, through which chips are received as they are broken away from the workpiece and, by centrifugal force, thrown clear from the tool. Tests demonstrate that the load experienced by the machine drilling a complex hole, such as that seen in FIG. 8, is significantly reduced and the objectives of the invention achieved. More specifically, and in contrast to the straight flute of the '978 patent, this improved tool also minimizes the tendency for the tool to deflect away from the side wall, which would otherwise distort the hole being drilled. Thus, a positive rake results in the hole being cut more accurately and with a better finish than previously available.

Referring now to FIG. 4, an improvement to the straight wall of prior flutes is shown. In the FIG. 4 embodiment, the walls 37, 39 defining the flute are formed with a slight arcuate grind to create a slight curvature which, nonetheless, in no way adversely effects the positive rake angle formed on the flutes, and, as a consequence, achieves the objectives attributable to the present invention.

Referring to FIG. 1, the support section defines a cavity adjacent the cutter insert 26, defined by an interior wall 44. The wall 44 permits chips formed by the cutting process to be expelled from the cutting area and coolant to be injected at the cutting edges to cool and lubricate the cutting surfaces.

It will now be appreciated that while the present invention has been described within a particular environment, the principles are easily adapted to a variety of alternative elements which will occur to those skilled in the art. Those alternatives are within the contemplation of the invention as described and claimed as follows:

1. In a high performance cutting tool for forming complex holes in a work piece such as an automotive aluminum wheel, or the like,
said tool having an elongated, generally cylindrical, body symmetrically formed about a longitudinal axis, said elongated body having a shank, and an integrally formed support section;
a longitudinally extending slot in said support section, said slot extending inwardly from said tip to a predetermined depth along the longitudinal axis of said cylindrical axis;
an elongated cutting insert, said insert having a tip and a base, a pair of diametrically opposed flutes extending between said tip and said base, each of said flutes being formed with a positive rake angle;
said cutter insert being formed of a relatively flat carbide material, and having a plurality of cutting edges formed thereon, said cutting edges being angularly disposed with respect to one another;
said insert being secured by brazing the same with tri-ply solder in said slot such that as said tool is rotated about its longitudinal axis, said cutting edges contact the work piece to form a complex hole therein.

2. The tool as set forth in claim 1, wherein said angle is within a range determined variously by the diameter and length of said tool.

3. The tool as set forth in claim 1, wherein said flutes define an arc relative to the longitudinal axis of said tool.

4. The tool as set forth in claim 1, wherein said flute portions together define a pair of opposed grooves through which liquids may be transferred to said cutting edges and material cut from a work piece may be carried away.

5. The tool as set forth in claim 1, wherein each said flute is formed with a slight helical curvature relative to said longitudinal axis.

6. A cutting insert for use in a drill comprising a relatively flat blank of carbide material; said blank having opposed side walls,
the perimeter of said blank having a plurality of cutting edges, said side walls each having a positive rake.
